(19) United States
(12) Patent Application Publication
(10) Pub. No.: US 2013/0121701 A1
(43) Pub. Date: May 16, 2013

(54) OPTICALLY-CONNECTED SYSTEM FOR EXCHANGING DATA AMONG INDUSTRIAL AUTOMATION DEVICES

(71) Applicant: FIDIA S.P.A., San Mauro Torinese (IT)

(72) Inventor: Giuseppe Morfino, Pino Torinese (IT)

(73) Assignee: FIDIA S.P.A., San Mauro Torinese (IT)

(21) Appl. No.: 13/737,571

(22) Filed: Jan. 9, 2013

Related U.S. Application Data
(63) Continuation-in-part of application No. 13/542,585, filed on Jul. 5, 2012.
Application No. 13/542,585 is a continuation-in-part of application No. 12/355,669, filed on Jan. 16, 2009, now abandoned.
Application No. 12/355,669 is a continuation-in-part of application No. 10/432,125, filed on Sep. 26, 2003, now abandoned.

(51) Int. Cl. H04B 10/00

(52) U.S. Cl. CPC H04B 10/1143
USPC 398/108

(57) ABSTRACT

An optically-connected system is disclosed for exchanging data among industrial automation devices, that is composed of a plurality of connection elements, where each element comprises at least two pairs of optical transmitters and receivers on the main side, and one optical receiver on the opposing main side, that are opposite with respect to another pair of transmitters and receivers in a following element; and where each one of the transmitters and receivers is adapted to communicate with industrial automation devices to cooperate for exchanging data between elements, sending one interrogation signal requesting an identity of the receiver and the receiver is adapted to send to each corresponding response signal containing characteristics of the receiver.

### CROSS-REFERENCE TO RELATED APPLICATIONS

This application is a continuation-in-part of U.S. patent application Ser. No. 13/542,585 titled “Optically-Connected System for Exchanging Data Among Industrial Automation Devices,” filed Jul. 5, 2012, which is a continuation-in-part of U.S. patent application Ser. No. 12/355,669 titled “Optically-Connected System for Exchanging Data Among Industrial Automation Devices,” filed Jan. 16, 2009, now abandoned, which is a continuation-in-part of U.S. patent application Ser. No. 10/432,125 entitled “Optical Connection System,” filed Sep. 26, 2003, now abandoned, which claims priority from International Patent Application No. PCT/IT02/00423 titled “Optically-Connected System for Exchanging Data Among Industrial Automation Devices,” filed Jun. 26, 2002, now expired, the contents of which are incorporated by reference herein in their entirety.

### FIELD OF THE INVENTION

The present invention refers to an optically-connected system, in particular an optically-connected system that uses electro-magnetic waves and a protocol for exchanging data among industrial automation devices.

### SUMMARY

The present invention overcomes the limitations of the prior art by providing an optically-connected system for exchanging data among industrial automation devices that has a plurality of connection elements, where each connection element has a main side and an opposing main side, and, perpendicular to the main sides, a minor side and an opposing minor side. At least two pairs of optical transmitters and receivers are affixed to each one of the connection elements, where each pair of the optical transmitters and receivers is further placed on the main side of the connection elements in an opposite way with respect to another pair of the transmitters and receivers in a following connection element, in such a way as to place on each main side of the connection elements one transmitter followed by one receiver eventually followed by one transmitter. The system also has one optical transmitter on the main side of each one of the connection elements, and one optical receiver on the opposing main side of each one of the connection elements affixed to each pair of the optical transmitters and receivers. Each one of the transmitters and receivers is adapted to communicate with one or more industrial automation devices. Also, each one of the transmitters and receivers is adapted to cooperate with the other connection elements for exchanging data with a respective receiver and transmitter of another adjacent to the connection elements. Moreover, each one of the transmitters is adapted to send to each corresponding receivers, one interrogation signal requesting an identity of the receiver, and each one of the receivers is adapted to send to each corresponding requesting transmitter a response signal containing characteristics of the receiver, the response signal identifying each receiver as a receiver that passes information from a first one of the transmitters to a last one of the receivers, the response signal of the last one of the receivers containing information identifying the last one of the receivers as an end receiver of the system. Finally, the system has an optical beam transmitted through the system that is a combination of a beam transmitted by each connection element and a beam received by a following connection element.

At least one of the connection elements is equipped on one of its minor sides with at least one additional pair of transmitters and receivers.

The connection elements of the optically-connected system are placed inside a box for industrial automation, each one of the boxes being equipped with openings adjacent to the transmitters and receivers in order to allow their mutual operability and with openings adjacent to the at least one additional pair of transmitters and receivers in order to allow their operability. The transmitters and receivers operate according to a protocol that is selected from IrDa, LiFi, IEEE 802.15 WPAN or IrLap. Also, each pair of the transmitters and receivers is connected to a respective encoder/decoder that is in turn connected to a control and management device. The control and management device is connected, through an I/O interface, to a terminal board for power supply and signal input/output to connect the box to one or more external industrial automation devices. The I/O interface can be serial, parallel, UART, USB, Ethernet or wireless. The control and management device is composed of the I/O interface and a microprocessor. Each of the transmitters and receivers is connected to a respective encoder/decoder, that is in turn connected to a control and management device. The control and management device is connected, through the I/O interface, to a terminal board for power supply and signal input/output from one or more than one external industrial automation device.

The optical transmitters and receivers transmit and receive electromagnetic waves that can be from a laser, microwave, infrared or visible light. The system further comprises a power supply attached to each one of the connection elements that is separate from the system. A detachable serial connection terminal board can provide the power supply.

The connection elements further comprise a plurality of data input and output elements respectively connected to other industrial automation devices and a data collecting and queuing element operatively connected to the data input and output elements, the elements being connected, through a field bus, to a numeric control for managing data.

There is also provided a method for exchanging data among industrial automation devices comprising the steps of: providing the optically-connected system and starting transmission and reception of data among the industrial automation devices. Each of the industrial automation devices is connected to one of the connection elements.

### BACKGROUND

Industrial automation data exchange systems for exchanging data within an automated industrial assemblage, such as a manufacturing assembly line, generally comprise a plurality of adjacent connection elements that are interconnected, such as for example on a DIN-type bar. Each connection element comprises input lines and output lines connecting the system to external devices, such as, for example, actuators, console lights, contactors, electric motors, sensors, switches and valves. The connection elements are further connected to a data collecting and ordering element (“power terminal”), which sends data collected from the different external devices through a field bus to an upstream numeric control. A serial connection is used to exchange data between the connection elements and the data collecting and ordering element. The connection elements and the data collecting and ordering elements are placed within a container having various configurations that can be assembled on DIN-type bars or other suitable devices.

Industrial automation data exchange systems constructed in this manner have several disadvantages. First, in some cases, failure of one of the connection elements requires disassembly of a whole row of otherwise functioning connection elements to remove and replace the failed connection element. In other cases, failure of one of the connection element requires cessation of the entire industrial automation data exchange system to replace the connection element because of the serial connection between the connection elements. In either case, if a replacement connection element is not available, the entire industrial automation system can cease functioning.

Further disadvantageously, some of the containers holding the connection elements and the data collecting and ordering element are structurally complex and, therefore, costly to produce, while other containers containing the connection elements and the data collecting and ordering element are simpler in structure but lack some desirable functions for industrial automation data exchange. Further disadvantageously, the physical connections between the connection elements are subject to wear, dirt and other environmental factors, including electromagnetic disturbances, that impair the function of the physical connections and, therefore, the function of the industrial automation data exchange system. Further disadvantageously, the amount of power that can be provided through the serial connection is limited to 8 or 16 connection elements having digital outputs of 250 mA. If more than 16 connection elements are needed, it is necessary to provide an additional industrial automation data exchange system serially connected to the first industrial automation data exchange system which increases the cost of the entire industrial automation data exchange system.

Therefore, there is a need for an industrial automation data exchange system that does not have these disadvantages.

### BRIEF DESCRIPTION OF THE DRAWINGS

These and other features, aspects and advantages of the present invention will become better understood with regard to the following description, appended claims, and accompanying figures where:

FIG. 1 is a schematic diagram of one embodiment of the industrial automation data exchange system according to the present invention;

FIG. 2 is a schematic perspective view of an industrial connection box that can be used with the present invention;

FIG. 3 is a bottom view of the industrial connection box in FIG. 2;

FIG. 4 is a schematic side view of a plate that points out the optically-connected system of the invention;

FIG. 5 is a front view of the plate in FIG. 4;

FIG. 6 is a schematic operating view of the optically-connected system of the invention;

FIG. 7 is a schematic block diagram of the main components necessary for implementing the optically-connected system of the present invention; and

FIG. 8 is a schematic block diagram of a series of I/O modules.

### DETAILED DESCRIPTION

According to one embodiment of the present invention, there is provided an industrial automation data exchange system that uses electromagnetic waves for exchanging data. In a preferred embodiment, the industrial automation data exchange system exchanges data within an automated industrial assemblage, such as a manufacturing assembly line, or between the automated industrial assemblage and other devices such as industrial automation devices, or both within an automated industrial assemblage and between the automated industrial assemblage and other devices; however, the system can be used to exchange data within or between other types of devices that use a power supply and data exchange bus, as will be understood by those with skill in the art with respect to this disclosure.

According to another embodiment of the present invention, there is provided a method for exchanging data using electromagnetic waves within an automated industrial assemblage, such as a manufacturing assembly line, or between the automated industrial assemblage and other devices such as industrial automation devices, or both within an automated industrial assemblage and between the automated industrial assemblage and other devices. The method comprises providing an industrial automation data exchange system according to the present invention.

Advantageously, the industrial automation data exchange system of the present invention is simple to construct, install, use and maintain, and therefore, costs less to manufacture and use than prior industrial automation data exchange systems. Further, using electromagnetic waves to exchange data between the connection elements of the present system renders the industrial automation data exchange system of the present invention more efficient and reliable than prior industrial automation data exchange systems that use physical connectors to exchange data. Additionally, if one connection element of the present industrial automation data exchange system becomes defective, the defective connection element can be quickly replaced without impairing the function of the remainder of the connection elements in the industrial automation data exchange system. Further, the industrial automation data exchange system of the present invention is less sensitive to environmental factors, such as for example dirt, electromagnetic disturbances, noise and vibrations that impair the function of industrial automation data exchange systems that use physical connectors to exchange data. The industrial automation data exchange system and method of the present invention will now be disclosed in detail.

According to one embodiment of the present invention, there is provided an industrial automation data exchange system comprising a plurality of connection elements that use electromagnetic waves for exchanging data between the connection elements. In a preferred embodiment, the industrial automation data exchange system exchanges data within an automated industrial assemblage, such as a manufacturing assembly line, or between the automated industrial assemblage and other devices, or both within an automated industrial assemblage and between the automated industrial assemblage and other devices; however, the system can be used to exchange data within or between other types of devices that use a power supply and data exchange bus, as will be understood by those with skill in the art with respect to this disclosure.

In another embodiment, there is provided an optically-connected system for exchanging data among industrial automation devices, the system comprising a plurality of connection elements. Each connection element has a main side and an opposing main side, and, perpendicular to the main sides, a minor side and an opposing minor side. Each one of the connection elements comprises at least two pairs of optical transmitters and receivers. Each pair of the optical transmitters and receivers comprises one optical transmitter on the main side of each one of the connection elements, and one optical receiver on the opposing main side of each one of the connection elements. Each pair of the optical transmitters and receivers is further placed on the main side of the connection elements in an opposite way with respect to another pair of the optical transmitters and receivers in a following connection element, in such a way as to place on each main side of the connection element one transmitter followed by one receiver eventually followed by one transmitter. Each one of the optical transmitters and receivers is adapted to communicate with industrial automation devices. Each one of the optical transmitters and receivers is adapted to cooperate for exchanging data with a respective receiver and transmitter of another adjacent to the connection element. Each one of the optical transmitters is adapted to send to each corresponding one of the receivers one interrogation signal requesting an identity of the receiver, and each one of the receivers is adapted to send to each corresponding requesting transmitter a response signal containing characteristics of the receiver, the response signal identifying each receiver as a receiver that passes information from a first one of the optical transmitters to a last one of the receivers, the response signal of the last one of the receivers containing information identifying the last one of the receivers as an end receiver of the system. An optical beam transmitted through the system is a combination of a beam transmitted by each connection element and a beam received by a following connection element.

In another embodiment, at least one of the connection elements is equipped on one of its minor sides with at least one additional pair of optical transmitters and receivers. Each of the connection elements is placed inside a box for industrial automation, each one of the boxes being equipped with openings next to the optical transmitters and receivers in order to allow their mutual operability. In another embodiment, the connection elements are placed inside a box for industrial automation, each one of the boxes being equipped with openings obtained next to the optical transmitters and receivers in order to allow their mutual operability and with openings obtained next to the at least one additional pair of optical transmitters and receivers in order to allow their operability.

In another embodiment, the optical transmitters and receivers transmit and receive infrared rays, or operate according to the IrDa protocol. Each pair of the optical transmitters and receivers is connected to a respective encoder/decoder that is in turn connected to a control and management device. The control and management device is connected, through an I/O interface, to a terminal board for power supply and signal input/output from one or more than one external industrial automation device. Optionally, the control and management device is composed of a UART-type element and a microprocessor. Each path of the optical transmitters and receivers is connected to a respective encoder/decoder that is in turn connected to a control and management device. In another embodiment, the control and management device is connected, through an I/O interface, to a terminal board for power supply and signal input/output from one or more than one external industrial automation device.

In another embodiment, the optically-connected system further comprises a power supply to each one of the connection elements that is separate from the optically-connected system.

In another embodiment, the connection elements further comprise a plurality of data input and output elements respectively connected to industrial automation devices. The connection elements further comprise a data collecting and queuing element operatively connected to the data input and output elements, the element being connected, through a field bus, to a numeric control for managing data.

In another embodiment, there is provided a method for exchanging data among industrial automation devices by first providing a system according to this disclosure. Then, starting transmission and reception of data among the industrial automation devices. In one embodiment, each of the industrial automation devices is connected to one of the connection elements.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a system or device disclosed in this disclosure will be determined by its intended use.

Methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. Although a flowchart may describe the operations as a sequential process, many of the operations can be performed in parallel, distributed or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, distributed, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc.

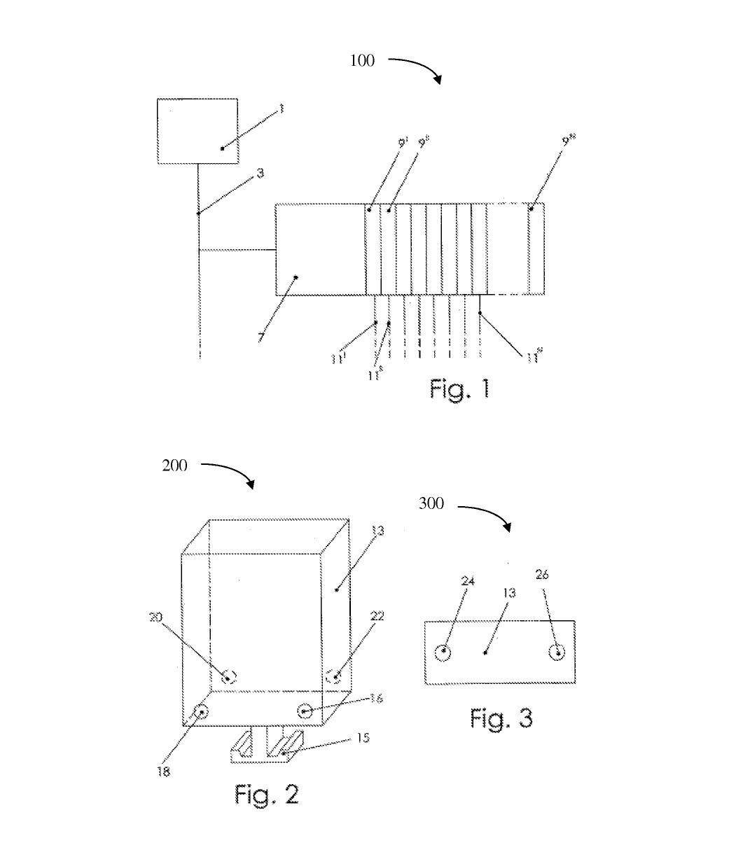

Referring now to FIG. 1, there is shown a schematic diagram 100 of one embodiment of an optically-connected system 100 for data exchange between industrial automation devices according to the present invention. As can be seen, the optically-connected system 100 for exchanging data among industrial automation devices comprises a plurality of connection elements 9′, 9″, . . . , 9ⁿ operably connected to a control and management element 7 through a field bus 3, to an upstream numeric control device 1 used for managing data in the system 100.

Each of the connection elements 9′, 9″, . . . , 9ⁿ are galvanically insulated from each other. Additionally, each of the connection elements 9′, 9″, . . . , 9ⁿ comprises at least one pair of optical transmitters 30, 32 and receivers 28, 34. In one embodiment, the optical transmitters 30, 32 and optical receivers 28, 34 transmit and receive electromagnetic waves. The transmitters 30, 32 and receivers 28, 34 use electromagnetic waves selected from the group consisting of laser, microwave, infrared or visible light.

The optical transmitters 30, 32 can be located on the main side of each one of the connection elements 9′, 9″, . . . , 9ⁿ and one of the optical receivers 28, 34 can be placed on an opposed main side 12 of each one of the connection elements 9′, 9″, . . . , 9ⁿ. Moreover, each one of the optical transmitters 30, 32 and receivers 28, 34 is adapted to cooperate for exchanging data with a respective transmitters 30, 32 and receivers 28, 34 of one or more different adjacent connection elements 9′, 9″, . . . , 9ⁿ.

According to another preferred embodiment, the optically-connected system 100 for exchanging data among industrial automation further comprises at least two pairs of optical transmitters 30, 32 and optical receivers 28, 34. Each pair of optical transmitters 30, 32 and optical receivers 28, 34 are located on a main side 10 of each one of the connection elements 9′, 9″, . . . , 9ⁿ. The optical receivers 28, 34 are located opposite to an opposing main side 12 of each one of the connection elements 9′, 9″, . . . , 9ⁿ. To guarantee the operating functionality of the connection elements 9′, 9″, . . . , 9ⁿ independently from the orientation with which they are assembled, such as, for example, on a DIN-type bar, each pair of optical transmitters 30, 32 and optical receivers 28, 34 is located on both of the main sides 10, 12 of the connection elements 9′, 9″, . . . , 9ⁿ in an opposite way with respect to the previous pair in such a way as to place on each main side 10, 12 of the connection elements 9′, 9″, . . . , 9ⁿ. As can be seen, this arrangement provides one transmitter 30, 32 followed by one receiver 28, 34, eventually followed by one transmitter 30, 32 (not shown) and so on. Also in this case, each one of the transmitters 30, 32 and receivers 28, 34 is adapted to cooperate for exchanging data with a respective receiver 28, 34 and transmitter 30, 32 of another adjacent to the connection elements 9′, 9″, . . . , 9ⁿ.

In order to allow installation and connection of a higher number of connection elements 9′, 9″, . . . , 9ⁿ, according to the requirements for the particular industrial application, at least one of the connection elements 9′, 9″, . . . , 9ⁿ can further be equipped, on one of its minor sides 14 perpendicular to the main sides 10, 12 on which the transmitters 30, 32 and receivers 28, 34 are placed, with at least one further pair of transmitters 30, 32 and receivers 28, 34 (not shown). In this case, two adjacent rows of connection elements 9′, 9″, . . . , 9ⁿ can be installed and data transmitted and received not only along the two rows, but also between one row and the other, with an optical “perpendicular” connection between an element of a row and the corresponding element below in the other row.

The connection elements 9′, 9″, . . . , 9ⁿ are respectively connected through digital inputs/outputs 11′, 11″, . . . , 11ⁿ to other external industrial automation devices (not shown) and the data control and management element 7 is operatively connected to the data connection elements 9′, 9″, . . . , 9ⁿ.

The system 100 provides the following advantages:

1. If a connection elements 9′, 9″, . . . , 9ⁿ is removed, the system 100 continues uninterrupted operation.

2. If a connection error occurs during the installation phase, high voltage can be applied to one of the connection elements 9′, 9″, . . . , 9ⁿ damaging it, none of the other connection elements 9′, 9″, . . . , 9ⁿ will be damaged because all the connection elements 9′, 9″, . . . , 9ⁿ are galvanically insulated from each other. Therefore the industrial automation device remains operating, saving extensive downtime, time and money.

3. The connection elements 9′, 9″, . . . , 9ⁿ do not have to be located one beside the other. The connection elements 9′, 9″, . . . , 9ⁿ can be separated and divided into logically divisions depending on the type of transmission means used, the functionality of the connection elements 9′, 9″, . . . , 9ⁿ or to simplify routine maintenance.

Referring now to FIGS. 2 and 3, there is shown a schematic perspective view 200 and a bottom view 300 of a one or more than one industrial automation box 13 that can be used with the present invention. The one or more than one box 13 comprises connection means 15 to connect the box 13 to a terminal bar (not shown), such as, for example, a DIN type bar. Each box 13 attached to the terminal bar comprises openings 16, 18, 20, 22 aligned next to the transmitters 30, 32 and the receivers 28, 34 to allow mutual operability between the boxes. Optionally, the one or more than one box 13 can comprise perpendicular connection elements. The optional perpendicular connection elements will also comprise openings 24, 26 aligned next to another pair of transmitters 30, 32 and receivers 28, 34 present on the minor side 14.

The box 13 can use a variety of protocols for exchanging data between the connection elements 9′, 9″, . . . , 9ⁿ including, but not limited to IrDa, LiFi, IEEE 802.15 WPAN or IrLap. Preferably, the optical transmitters 30, 32 and optical receivers 28, 34 use optical rays at infrared frequency, and use the IrDa protocol to operate.

The connection elements 9′, 9″, . . . , 9ⁿ are placed inside respective boxes 13 for industrial automation for use with the present invention. However, it is not necessary that such boxes 13 be of a particularly complicated and costly shape or configuration. Instead, the boxes 13 are chosen so that the boxes 13 are as inexpensive as possible.

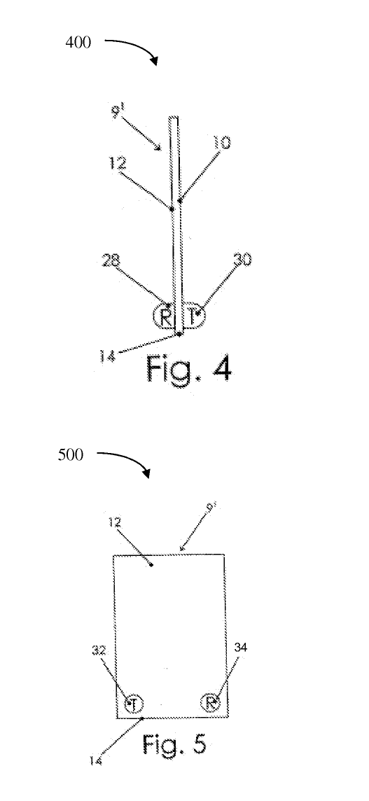

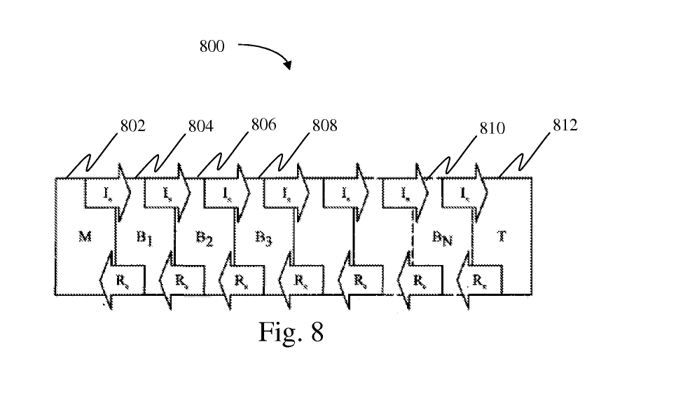

Referring now to FIGS. 4 and 5, there is respectfully shown a schematic side view of a plate 400 and a front view of a plate 500 and a connection element of the optically-connected system 100. As can be seen, the optical transmitters 30, 32 and optical receivers 28, 34 are located on the lower portion of the connection elements 9′, 9″, . . . , 9ⁿ. In this configuration, the optical transmitters 30, 32 are located on one main side 10, while the optical receivers 28, 34 are located on the opposing main side 12. In this configuration all optical transmitters 30, 32 and optical receivers 28, 34 will be placed into the system 100 in a serial manner, as also shown in FIG. 8. All the data will be transmitted and exchanged through each of the connection elements 9′, 9″, . . . , 9ⁿ along the optical transmitters 30, 32 until the last connection element 9ⁿ is reached. Then, the data will be exchanged between the receivers 28, 34 and the data control and management element 7, along field bus 3 to the control device 1.

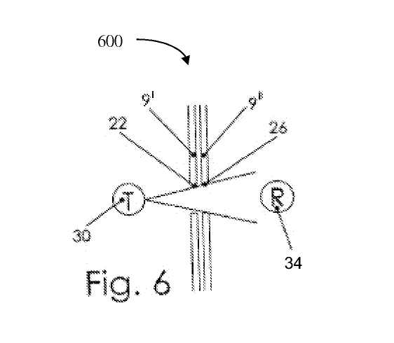

Referring now to FIG. 6, there is shown a schematic operating view 600 of the optically-connected system 100. As can be seen optical transmitter 30 pulses electromagnetic waves through opening 22 in connection element 9′ where optical receiver 34 detects the data to be exchanged through connection element 9″ through opening 26.

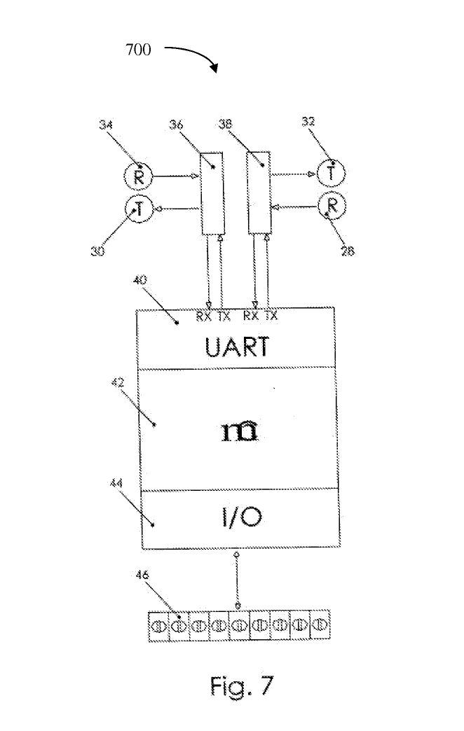

Referring now to FIG. 7, there is shown a schematic block diagram 700 for implementing the optically-connected system 100 according to one embodiment of the present invention. As can be seen, the optically-connected system comprises at least two optical transmitters 30, 32 and optical receivers 28, 34 that are connected to a respective encoder/decoder 36, 38. The encoder/decoder 36, 38 are connected to control and management means 40, 42. The optically-connected system where each pair of the transmitters and receivers is connected to a respective encoder/decoder, that is in turn connected to a control and management device, where the control and management device is connected, through an I/O interface, to a terminal board for power supply and signal input/output from one or more than one external industrial automation device, and where the I/O interface is selected from the group consisting of serial, parallel, UART, USB, Ethernet and wireless. Preferably, the control and management means are a UART 40 and a microprocessor 42. The control and management means 40, 42 are connected, through the I/O interface 44, to a terminal board 46 for power supply and signal input/output data communication channels from other external industrial automation devices (not shown).

The power supplied to each one of the connection elements 9′, 9″, . . . , 9ⁿ can be provided separately with respect to the optically-connected system 100, such as, for example, by serial connections, small cables, or using detachable connection terminal boards, in order to facilitate power supply disconnection and reconnection operations when replacing or maintaining the connection elements 9′, 9″, . . . , 9ⁿ and/or the boxes 13.

Referring now to FIG. 8, there is shown a schematic block diagram 800 of a series of I/O modules. The modules operate as follows: first, a required number of I/O modules are provided. The I/O modules comprise a master module (M) 802 and a termination module (T) 812. Additional I/O modules (B₁, B₂, B₃, . . . , B_{N}) 804, 806, 808 and 810 can be placed side by side between the master module (M) 802 and the termination module (T) 812 according to an “Easy chain” configuration in order to allow an optical transmission of an interrogation signal (I_{S}) and a response signal (R_{S}) in opposite directions. Next, the I/O modules are energized. Then, the master module (M) 802 sends a first interrogation signal I_{S} to the first following I/O module B₁ 804 requesting a module identification response (i.e. “which kind of module is it?”). Next, the I/O module B₁ 804 transmits a first response signal R_{S} communicating the module's characteristics to the master module (M) 802 which stores the information. Then, the I/O module B₁ 804 becomes a “passing” module for the following optical signals. Next, the master module (M) 802 sends a second interrogation signal I_{S} to the next I/O module B₂ 806 through the preceding I/O module B₁ 804 requesting a module identification response. Then, I/O module B₂ 806 replies with a second response signal R_{S} that passes through the preceding I/O module B₁ 804 communicating its characteristics to the master module (M) 802. Then, the I/O module B₂ 806 becomes a “passing” board for the following optical signals. Next, the remaining I/O modules B₃, . . . , B_{N} are sequentially sent an interrogation signal I_{S}, as described above, until the master module (M) 802 interrogates the terminator module (T) 812 by passing the interrogation signal I_{S} through all the preceding I/O modules B₁, B₂, B₃, . . . , B_{N}. The terminator module (T) 812 answers through the preceding I/O modules B₁, B₂, B₃, . . . , B_{N} by a response signal R_{S} communicating to the master module (M) 802 that the chain is terminated. After powering the chain of I/O modules B₁, B₂, B₃, . . . , B_{N}, the master module (M) 802 immediately knows the entire configuration of the chain and, particularly, the characteristics of all the I/O modules B₁, B₂, B₃, . . . , B_{N}. The terminator module (T) 802 provides information to the master module (M) 802 that the chain of I/O modules is terminated. Without the termination module (T) 812 a failed module along the chain which, for example, interrupts the transmission of optical signals through the chain itself, can provide false information to the master module (M) 802 that would make the chain shorter than what it really is. The presence of the terminator module (T) 812 makes the operations of the Applicant's board extremely reliable and transparent.

What has been described is a new and improved optically-connected system that uses electro-magnetic waves and a protocol for exchanging data among industrial automation devices., overcoming the limitations and disadvantages inherent in the related art.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. §112.

What is claimed is:

1. An optically-connected system for exchanging data among industrial automation devices comprising:
a) a plurality of connection elements;
where each connection element has a main side and an opposing main side, and, perpendicular to the main sides, a minor side and an opposing minor side;
b) at least two pairs of optical transmitters and receivers affixed to each one of the connection elements,
where each pair of the optical transmitters and receivers is further placed on the main side of the connection elements in an opposite way with respect to another pair of the optical transmitters and receivers in a following connection element, in such a way as to place on each main side of the connection elements one transmitter followed by one receiver eventually followed by one transmitter;
c) one optical transmitter on the main side of each one of the connection elements, and one optical receiver on the opposing main side of each one of the connection elements affixed to each pair of the optical transmitters and receivers,
where each one of the transmitters and receivers is adapted to communicate with one or more industrial automation devices,
where each one of the transmitters and receivers is adapted to cooperate for exchanging data with a respective receiver and transmitter of another adjacent to the connection elements,
where each one of the transmitters is adapted to send to each corresponding one of the receivers one interrogation signal requesting an identity of the receiver, and each one of the receivers is adapted to send to each corresponding requesting transmitter a response signal containing characteristics of the receiver, the response signal identifying each receiver as a receiver that passes information from a first one of the transmitters to a last one of the receivers, the response signal of the last one of the receivers containing information identifying the last one of the receivers as an end receiver of the system, and
where an optical beam transmitted through the system is a combination of a beam transmitted by each connection element and a beam received by a following connection element.

2. The optically-connected system of claim 1, where at least one of the connection elements is equipped on one of its minor sides with at least one additional pair of transmitters and receivers.

3. The optically-connected system of claim 1, where each of the connection elements is placed inside a box for industrial automation, each one of the boxes being equipped with openings next to the transmitters and receivers in order to allow their mutual operability.

4. The optically-connected system of claim 3, where the openings are adjacent to the at least one additional pair of transmitters and receivers in order to allow their operability.

5. The optically-connected system of claim 4, where the transmitters and receivers operate according to a protocol.

6. The optically-connected system of claim 5, where the protocol is selected from the group consisting of IrDa, LiFi, IEEE 802.15 WPAN or IrLap.

7. The optically-connected system of claim 6, where each pair of the transmitters and receivers is connected to a respective encoder/decoder, that is in turn connected to a control and management device,
where the control and management device is connected, through an I/O interface, to a terminal board for power supply and signal input/output from one or more than one external industrial automation device.

8. The optically-connected system of claim 7, where the I/O interface is selected from the group consisting of serial, parallel, UART, USB, Ethernet and wireless.

9. The optically-connected system of claim 8, where the control and management device is composed of the I/O interface and a microprocessor.

10. The optically-connected system of claim 5, where each of the transmitters and receivers is connected to a respective encoder/decoder, that is in turn connected to a control and management device,
where the control and management device is connected, through the I/O interface, to a terminal board for power supply and signal input/output from one or more than one external industrial automation device.

11. The optically-connected system of claim 10, where the control and management device is composed of a UART and a microprocessor.

12. The optically-connected system according to claim 1, where the optical transmitters and receivers transmit and receive electromagnetic waves selected from the group consisting of laser, microwave, infrared or visible light.

13. The optically-connected system of claim 12, further comprising a power supply attached to each one of the connection elements that is separate from the optically-connected system.

14. The optically-connected system of claim 13, where the power supply is provided by a detachable serial connection terminal board.

15. The optically-connected system of claim 1, where the connection elements further comprise a plurality of data input and output elements respectively connected to industrial automation devices,
where the connection elements further comprise a data collecting and queuing element operatively connected to the data input and output elements, the element being connected, through a field bus, to a numeric control for managing data.

16. A method for exchanging data among industrial automation devices comprising:
a) providing a system according to claim 1; and
b) starting transmission and reception of data among the industrial automation devices,
where each of the industrial automation devices is connected to one of the connection elements.

17. An optically-connected system for exchanging data among industrial automation devices, the system comprising a plurality of connection elements;
where each connection element has a main side and an opposing main side, and, perpendicular to the main sides, a minor side and an opposing minor side;
where each one of the connection elements comprises at least two pairs of optical transmitters and receivers;
where each pair of the optical transmitters and receivers comprises one optical transmitter on the main side of each one of the connection elements, and one optical receiver on the opposing main side of each one of the connection elements;
where each pair of the optical transmitters and receivers is further placed on the main side of the connection elements in an opposite way with respect to another pair of the transmitters and receivers in a following connection element, in such a way as to place on each main side of the connection elements one transmitter followed by one receiver eventually followed by one transmitter;
where each one of the transmitters and receivers is adapted to communicate with industrial automation devices;
where each one of the transmitters and receivers is adapted to cooperate for exchanging data with a respective receiver and transmitter of another adjacent of the connection elements;
where each one of the transmitters is adapted to send to each corresponding one of the receivers one Interrogation signal requesting an identity of the receiver, and each one of the receivers is adapted to send to each corresponding requesting transmitter a response signal containing characteristics of the receiver, the response signal identifying each receiver as a receiver that passes information from a first one of the transmitters to a last one of the receivers, the response signal of the last one of the receivers containing information identifying the last one of the receivers as an end receiver of the system; and
where an optical beam transmitted through the system is a combination of a beam transmitted by each connection element and a beam received by a following connection element.
